(19) United States
(12) Patent Application Publication
(10) Pub. No.: US 2025/0058224 A1
(43) Pub. Date: Feb. 20, 2025

(54) LEVEL PICTURE DISPLAY

(71) Applicant: Tencent Technology (Shenzhen) Company Limited, Shenzhen (CN)

(72) Inventors: Chennan ZHANG, Shenzhen (CN); Fan ZHAO, Shenzhen (CN); Ruorong DU, Shenzhen (CN)

(73) Assignee: Tencent Technology (Shenzhen) Company Limited, Shenzhen (CN)

(21) Appl. No.: 18/934,195

(22) Filed: Oct. 31, 2024

Related U.S. Application Data
(63) Continuation of application No. PCT/CN2023/130005, filed on Nov. 6, 2023.

(30) Foreign Application Priority Data
Dec. 30, 2022 (CN) 202211737002.X

(51) Int. Cl. A63F 13/56; A63F 13/45

(52) U.S. Cl. CPC A63F 13/56; A63F 13/45

(57) ABSTRACT

In a display method, a virtual character in a first module of a level in a video game is displayed. The virtual character is controlled, based on a first interaction operation, to move from a first instance of the first module to a first instance of a second module of the level when a first condition of the first module is met. The virtual character is controlled, based on a second interaction operation, to move from the first instance of the second module to a second instance of the first module when a second condition of the second module is met. The virtual character is controlled, based on the second interaction operation, to move from the first instance of the second module to a third module of the level in the video game when the second condition of the second module and the loop end condition are met.

### RELATED APPLICATIONS

The present application is a continuation of International Application No. PCT/CN2023/130005, filed on Nov. 6, 2023, which claims priority to Chinese Patent Application No. 202211737002.X, filed on Dec. 30, 2022. The entire disclosures of the prior applications are incorporated herein by reference.

### FIELD OF THE TECHNOLOGY

Embodiments of this disclosure relate to the field of human-computer interaction, including to a level picture display method and apparatus, a device, a medium, and a program product.

### BACKGROUND OF THE DISCLOSURE

A side-scrolling game is a game in which a movement route of a game character is controlled on a moving surface. In pictures of the side-scrolling game, the movement route of the game character (a virtual character controlled by a player) is along a horizontal direction.

In the related art, as the game character moves, the client needs to load a level picture of a relevant region, to ensure integrity of a gaming experience of the player.

However, the length of the level picture of the relevant region is predetermined and may not meet the needs of the player, but directly increasing the length of the level picture leads to high performance pressure.

### SUMMARY

This disclosure provides a level picture display method and apparatus, a device, a medium, and a program product. The technical solutions are as follows:

According to an aspect of this disclosure, a display method, such as level picture display method, is provided. The method is performed by a terminal device, for example.

In the display method, a virtual character that is located in a first module of a level in a video game is displayed. The virtual character is controlled, based on a first interaction operation, to move from an end position of a first instance of the first module to a start position of a first instance of a second module of the level in the video game when a first condition of the first module is met. The virtual character is controlled, by processing circuitry and based on a second interaction operation, to move from an end position of the first instance of the second module to a start position of a second instance of the first module when a second condition of the second module is met. The virtual character is controlled, by the processing circuitry and based on the second interaction operation, to move from the end position of the first instance of the second module to a start position of a third module of the level in the video game when the second condition of the second module is met and the loop end condition is met.

According to another aspect of this disclosure, an information processing apparatus, such as a level picture display apparatus, is provided. The apparatus includes processing circuitry. that is configured to display a virtual character that is located in a first module of a level in a video game. The processing circuitry is configured to control, based on a first interaction operation, the virtual character to move from an end position of a first instance of the first module to a start position of a first instance of a second module of the level in the video game when a first condition of the first module is met. The processing circuitry is configured to control, based on a second interaction operation, the virtual character to move from an end position of the first instance of the second module to a start position of a second instance of the first module when a second condition of the second module is met. The processing circuitry is configured to control, based on the second interaction operation, the virtual character to move from the end position of the first instance of the second module to a start position of a third module of the level in the video game when the second condition of the second module is met and the loop end condition is met.

According to another aspect of this disclosure, a terminal device is provided. The terminal device includes a processor, a transceiver, and a memory. The transceiver is connected to the processor. The memory is configured to store a computer program of the processor. The processor is configured to load and execute the computer program to implement the foregoing level picture display method.

According to another aspect of this disclosure, a non-transitory computer-readable storage medium is provided. The non-transitory computer-readable storage medium stores instructions which when executed by a processor cause the processor to implement the foregoing level picture display method.

According to another aspect of this disclosure, a computer program product is provided. The computer program product includes a computer program, the computer program being stored in a computer-readable storage medium. A processor of a terminal device reads the computer program from the computer-readable storage medium, and executes the computer program, to cause the terminal device to implement the foregoing level picture display method.

Technical solutions provided in the aspects of this disclosure may include the following beneficial effects:

By cyclically loading the first module and the second module, the virtual character is controlled to move in the first module and the second module, so that the length of the level can be nearly infinite by loading only two modules by the client, and dynamic splicing adjustment can be performed according to the actual movement of the virtual character, thereby reducing performance pressure.

### BRIEF DESCRIPTION OF THE DRAWINGS

FIG. 1 is a structural block diagram of a computer system according to an example of an aspect of this disclosure.

FIG. 2 is a schematic diagram of a level picture display method according to an example of an aspect of this disclosure.

FIG. 3 is a flowchart of a level picture display method according to an example of an aspect of this disclosure.

FIG. 4 is a flowchart of a level picture display method according to an example of an aspect of this disclosure.

FIG. 5 is a flowchart of a level picture display method according to an example of an aspect of this disclosure.

FIG. 6 is a flowchart of a level picture display method according to an example of an aspect of this disclosure.

FIG. 7 is a flowchart of a level picture display method according to an example of an aspect of this disclosure.

FIG. 8 is a flowchart of a level picture display method according to an example of an aspect of this disclosure.

FIG. 9 is a flowchart of a level picture display method according to an example of an aspect of this disclosure.

FIG. 10 is a flowchart of a level picture display method according to an example of an aspect of this application.

FIG. 11 is a flowchart of a level picture display method according to an example of an aspect of this disclosure.

FIG. 12 is a schematic diagram of a level picture display method in the related art.

FIG. 13 is a schematic diagram of a level picture display method according to an example of an aspect of this disclosure.

FIG. 14 is a flowchart of a level picture display method according to an example of an aspect of this disclosure.

FIG. 15 is a schematic diagram of a level picture display method according to an example of an aspect of this disclosure.

FIG. 16 is a schematic diagram of a level picture display method according to an example of an aspect of this disclosure.

FIG. 17 is a schematic diagram of a level picture display method according to an example of an aspect of this disclosure.

FIG. 18 is a schematic diagram of a level picture display method according to an example of an aspect of this disclosure.

FIG. 19 is a schematic structural diagram of module information according to an example of an aspect of this disclosure.

FIG. 20 is a schematic diagram of a module splicing method according to an example of an aspect of this disclosure.

FIG. 21 is a schematic diagram of a loop setting interface according to an example of an aspect of this disclosure.

FIG. 22 is a schematic diagram of a module splicing method according to an example of an aspect of this disclosure.

FIG. 23 is a flowchart of a level picture display method according to an example of an aspect of this disclosure.

FIG. 24 is a flowchart of a level picture display method according to an example of an aspect of this disclosure.

FIG. 25 is a level picture display apparatus according to an example of an aspect of this disclosure.

FIG. 26 is a schematic structural diagram of a terminal device according to an example of an aspect of this disclosure.

### DESCRIPTION OF ASPECTS

When the following descriptions are made with reference to accompanying drawings, unless otherwise indicated, the same numbers in different accompanying drawings represent the same or similar elements. The following implementations described in the following example aspects do not represent all implementations that are consistent with this disclosure. Instead, they are merely examples of the apparatus and method according to some aspects of this disclosure.

The examples of terms used in this disclosure are for the purpose of describing example aspects only and are not intended to limit this disclosure. The singular forms of “a” and “the” used in this disclosure and the appended claims are intended to include the plural forms as well, unless the context indicates otherwise. The term “and/or” used herein indicates and includes any or all possible combinations of one or more associated listed items.

The use of “at least one of” or “one of” in the disclosure is intended to include any one or a combination of the recited elements. For example, references to at least one of A, B, or C; at least one of A, B, and C; at least one of A, B, and/or C; and at least one of A to Care intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Some examples of terms in this disclosure are briefly introduced as follows.

Side-scrolling game: a game in which a movement route of a game character may be controlled on a moving surface. For example, in all or most pictures of the side-scrolling game, the movement route of the game character (a master virtual character) is along a horizontal direction. According to content, the side-scrolling game is classified into a side-scrolling clearance game, a side-scrolling adventure game, a side-scrolling competition game, a side-scrolling strategy game, and the like; and according to technologies, the side-scrolling game is classified into a two-dimensional side-scrolling game and a three-dimensional side-scrolling game.

Side-scrolling virtual environment: a virtual environment displayed (or provided) when an application runs on a terminal device, for example, a virtual environment displayed when an application of a side-scrolling game runs. The side-scrolling virtual environment may be a simulated environment of a real world, or may be a semi-simulated and semi-fictional environment, or may be a fictional environment. The side-scrolling virtual environment may be any one of a two-dimensional virtual environment, a 2.5-dimensional virtual environment, and a three-dimensional virtual environment. This is not limited in this disclosure.

In some aspects, the side-scrolling virtual environment may provide a battle environment of a virtual object (a master virtual character controlled by a player or a virtual object controlled by a computer). Each client may control one or more virtual objects in the side-scrolling virtual environment. In some aspects, arena modes of the battle may include a single-player battle mode, a two-player team battle mode, or a multi-player team battle mode. This is not limited in this disclosure.

Virtual object: a movable object in the side-scrolling virtual environment. The movable object may be a virtual character, a virtual animal, a virtual plant, a virtual mechanism, or the like, for example, a character, an animal, a plant, and a mechanism displayed in the three-dimensional side-scrolling virtual environment. In some aspects, the virtual object is a three-dimensional model created based on an animation technology. Each virtual object has a shape and size in the three-dimensional side-scrolling virtual environment, and occupies some space in the three-dimensional side-scrolling virtual environment. In some aspects, the virtual object includes a game character (a master virtual character) controlled by a client/player, and a game character/virtual object controlled by a computer program.

Line: Points at which a virtual character in a side-scrolling game is movable in a game scene are connected as a line.

Module: a logical block of a level in a side-scrolling game. Monsters, the line, camera parameters, and the like in a level may be gathered into one module to facilitate processing by a program to process.

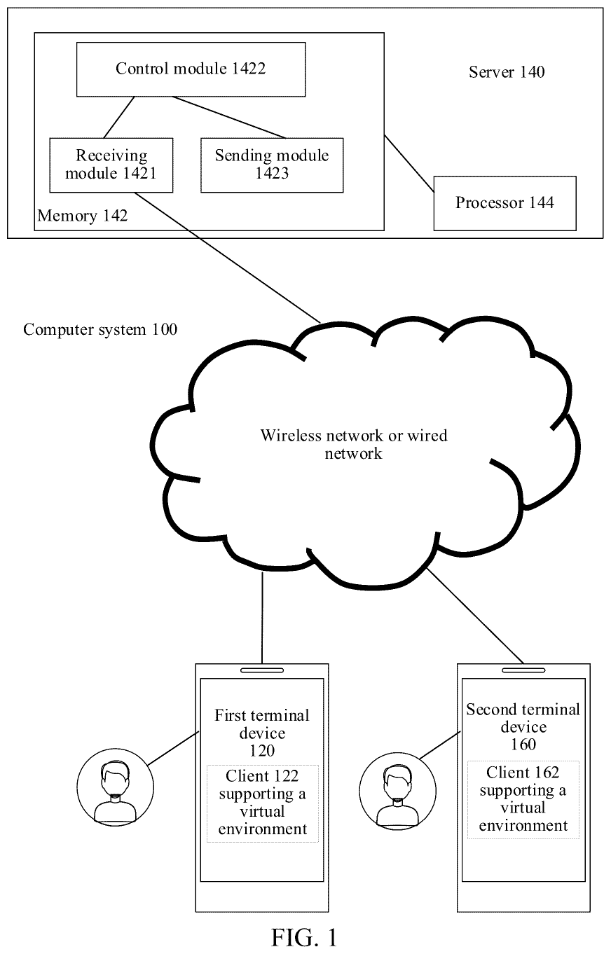

FIG. 1 is a structural block diagram of a computer system according to an example of an aspect of this disclosure. The computer system 100 includes: a first terminal device 120, a server 140, and a second terminal device 160.

A client 122 supporting a side-scrolling virtual environment is installed and run on the first terminal device 120. The client 122 supporting the side-scrolling virtual environment may be any one of a three-dimensional map application, a side-scrolling shooting application, a side-scrolling adventure application, a side-scrolling clearance application, a side-scrolling strategy application, a virtual reality (VR) application, or an augmented reality (AR) application. The terminal device may also be referred to as a terminal for short. The terminal device may be a smartphone, a tablet computer, a personal computer (PC), a wearable device, or the like. This is not limited in the aspects of this disclosure. The first terminal device 120 is a terminal device used by a first player. The first player uses the first terminal device 120 to control a first virtual object located in the side-scrolling virtual environment to perform an activity. The activity includes: at least one of adjusting a body posture, walking, running, jumping, riding, driving, aiming, picking up, using a throwing item, or attacking another virtual object. For example, if the first virtual object is a first virtual character, the first player controls the first virtual object to perform an activity through a user interface (UI) control on a side-scrolling virtual environment picture.

The first terminal device 120 is connected to the server 140 through a wireless network or a wired network. The server 140 includes at least one of a server, a plurality of servers, a cloud computing platform, or a virtualization center. For example, the server 140 includes a processor 144 and a memory 142. The memory 142 includes a receiving module 1421, a control module 1422, and a sending module 1423. The receiving module 1421 is configured to receive a request sent by the client; the control module 1422 is configured to control rendering of the side-scrolling virtual environment picture; and the sending module 1423 is configured to send a response to the client, for example, send the side-scrolling virtual environment picture to the client. The server 140 is configured to provide a backend service for the client supporting the side-scrolling virtual environment. In some aspects, the server 140 is responsible for primary computing work, and the first terminal device 120 and the second terminal device 160 are responsible for secondary computing work; or the server 140 is responsible for secondary computing work, and the first terminal device 120 and the second terminal device 160 are responsible for primary computing work; or the server 140, the first terminal device 120, and the second terminal device 160 perform collaborative computing by using a distributed computing architecture among each other.

A client 162 supporting a side-scrolling virtual environment is installed and run on the second terminal device 160. The client 162 supporting the side-scrolling virtual environment includes any one of a three-dimensional map application, a side-scrolling shooting application, a side-scrolling adventure application, a side-scrolling clearance application, a side-scrolling strategy application, a VR application, or an AR application. The second terminal device 160 is a terminal device used by a second user. The second user uses the second terminal device 160 to control a second virtual object located in the side-scrolling virtual environment to perform an activity. The activity includes: at least one of adjusting a body posture, walking, running, jumping, riding, driving, aiming, picking up, using a throwing item, or attacking another virtual object.

In some aspects, the first virtual object and the second virtual object are located in the same side-scrolling virtual environment. In some aspects, the first virtual object and the second virtual object may belong to the same team, the same organization, or the same camp, have a friend relationship with each other, or have a temporary communication permission. In some aspects, the first virtual object and the second virtual object may belong to different camps, different teams, or different organizations, or have a hostile relationship with each other.

In some aspects, the applications installed on the first terminal device 120 and the second terminal device 160 are the same, or the applications installed on the two terminal devices are the same type of applications on different operating system platforms. The first terminal device 120 may refer to one of a plurality of terminal devices, and the second terminal device 160 may refer to one of the plurality of terminal devices. In this disclosure, the first terminal device 120 and the second terminal device 160 are merely used as an example for description. Device types of the first terminal device 120 and the second terminal device 160 are the same or different. The device type includes: at least one of a smartphone, a tablet computer, an e-book reader, a laptop portable computer, or a desktop computer. In this disclosure, an example in which the terminal device includes a smartphone is used for description.

A person skilled in the art may learn that there may be more or fewer terminal devices. For example, there may be only one terminal device, or there may be dozens of or hundreds of terminal devices or more. The quantity and the device types of the terminal devices are not limited in the aspects of this disclosure.

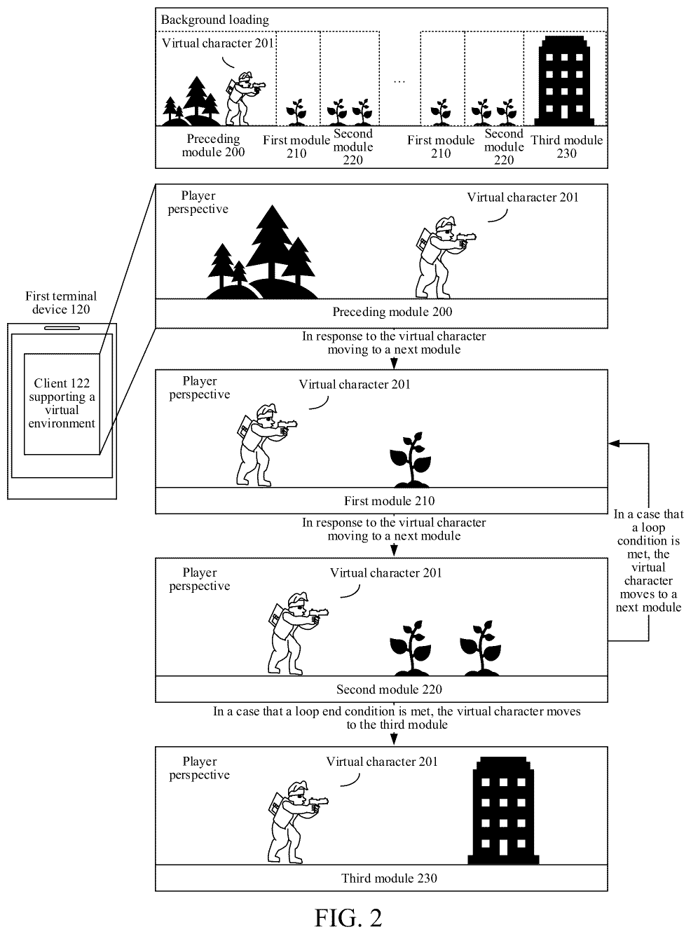

A side-scrolling game is a game in which a movement route of a game character is controlled on a moving surface. In all or most pictures of the side-scrolling game, the movement route of the game character (a virtual character controlled by a player) is along a horizontal direction. In the related art, as the game character moves, the client needs to load a level picture of a relevant region, to ensure integrity of gaming experience of the player. Content in the relevant region is pre-configured. Some scenes with an infinite length are actually of a finite length, but the finite length is large and may be considered as an infinite length. However, the length of the level picture of the relevant region is determined and cannot meet the needs of the player, but directly increasing the length of the level picture leads to high performance pressure. Therefore, a level picture display method that can increase the length of the level picture and has less performance pressure is needed. As shown in FIG. 2, FIG. 2 is a schematic diagram of a level picture display method according to an example of an aspect of this disclosure. The method is performed by the client 122 supporting a virtual environment in the first terminal device 120.

The client 122 supporting the virtual environment (the client 122 for short) is installed and run on the first terminal device 120. The client 122 displays a game picture from a player perspective. In this disclosure, a level is divided into a plurality of modules according to a logical relationship. The module is a minimum logic unit that can be run in a level, and includes at least one of the following: a line, a camera, a monster trigger, or a trigger. The line is a line formed by connecting points at which a virtual character 201 is movable in the level; the camera is configured to provide the level picture from the player perspective; the monster trigger is configured to display a monster in the module; and the trigger is configured to start or end loading the module. A module type includes at least one of the following: an ordinary module or a loop module, where the ordinary module includes a scene resource that does not cyclically occur, the loop module includes the same or similar scene resource that cyclically occurs, and the scene resource includes at least one of the following: an interaction mechanism, a virtual item, or a virtual character. In this disclosure, an example in which a first module 210 and a second module 220 are used as loop modules, and a preceding module 200 and a third module 230 are used as ordinary modules is used for description. In some aspects, the loop module is a module that participates in module repetition and that is used for a plurality of times; the preceding module is a module that is located before all loop modules and used only once; and the third module is a module that is located after all loop modules and used only once.

As shown in FIG. 2, the virtual character 201 controlled by the player moves to the preceding module 200. In this case, the preceding module 200 is displayed from the player perspective. The preceding module 200 includes a forest. When the virtual character 201 moves to the preceding module 200, a trigger of the first module 210 is triggered, and the client 122 starts to load all content of the first module 210. The scene resources in the loop module may be the same or different. In this disclosure, an example in which the first module 210 and the second module 220 include different scene resources are used for description. The first module 210 includes a sapling, and the second module 220 includes two saplings.

To avoid a situation in which the scene resources and the monster have not been displayed after the virtual character 201 moves to the module, when loading all the content of the first module, the client 122 further loads part of the content of the second module, and a trigger of each module is set in a previous module. For example, when loading all the content of the first module 210, the client 122 further loads part of the content of the second module 220. The part of the content includes content with less performance pressure, such as a logical relationship and a background picture.

A trigger of the second module 220 is set in the first module 210. When the virtual character 201 moves to the first module 210, the trigger of the second module 220 is triggered, and scene resources and other content that has high performance pressure on the client 122 in the second module 220 are loaded. In addition, when the virtual character 201 moves to the first module 210 for the first time, the client 122 determines whether to cyclically load the first module 210 and the second module 220, that is, whether to start a loop, and perform a corresponding operation.

In a case that the client 122 determines to start a loop, when the virtual character 201 moves to the second module 220, the client 122 loads the first module 210. That is, in a case that a loop condition is met, a next module to which the virtual character moves is the first module 210. Then, the client 122 cyclically loads the first module 210 and the second module 220, and the first module 210 and the second module 220 are cyclically displayed from the player perspective. In a case that the client 122 determines not to start a loop, when the virtual character 201 moves to the second module 220, the client 122 loads the third module 230. That is, when a loop end condition is met, a next module to which the virtual character moves is the third module 230. The third module 230 includes a building.

In conclusion, in the method provided in this aspect, by cyclically loading the first module and the second module, the virtual character is controlled to move in the first module and the second module, so that the length of the level can be nearly infinite by loading only two modules by the client, and dynamic splicing adjustment can be performed according to the actual movement of the virtual character, thereby reducing performance pressure.

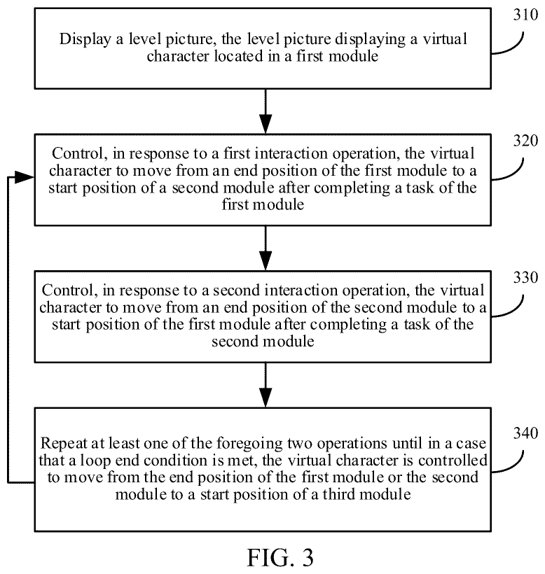

FIG. 3 is a flowchart of a level picture display method according to an example of an aspect of this disclosure. The method is performed by a client, for example. The method may include at least one of the following operations 310 to 340.

Operation 310: Display a level picture, the level picture displaying a virtual character located in a first module. In an example, a virtual character that is located in a first module of a level in a video game is displayed.

A level is divided into a plurality of modules according to a logical relationship. The module is a minimum logic unit that can be run in a level, and includes at least one of the following: a line, a camera, a monster trigger, or a trigger. The line is a line formed by connecting points at which a virtual character is movable in the level; the camera is configured to provide the level picture from the player perspective; the monster trigger is configured to display a monster in the module; and the trigger is configured to start or end loading the module.

A module type includes at least one of the following: an ordinary module or a loop module, where the ordinary module includes a scene resource that does not cyclically occur, the loop module includes the same or similar scene resource that cyclically occurs, and the scene resource includes at least one of the following: an interaction mechanism, a virtual item, or a virtual character. In this aspect, an example in which a first module and a second module are used as loop modules, and a third module is used as an ordinary module is used for description.

Operation 320: Control, in response to a first interaction operation, the virtual character to move from an end position of the first module to a start position of a second module after completing a task of the first module. In an example, the virtual character is controlled, based on a first interaction operation, to move from an end position of a first instance of the first module to a start position of a first instance of a second module of the level in the video game when a first condition of the first module is met.

The virtual character includes a game character controlled by a client/player and a game character controlled by a computer program. For example, in response to a movement operation, the player controls the virtual character to complete a task of passing through the first module and move from the end position of the first module to the start position of the second module.

In some aspects, the task is also referred to as a module task. The module task is a task that needs to be completed by controlling the virtual character in a corresponding module. For example, the task of the first module is a task that needs to be completed by controlling the virtual character in the first module.

Operation 330: Control, in response to a second interaction operation, the virtual character to move from an end position of the second module to a start position of the first module after completing a task of the second module. In an example, the virtual character is controlled, by processing circuitry and based on a second interaction operation, to move from an end position of the first instance of the second module to a start position of a second instance of the first module when a second condition of the second module is met.

Since the first module and the second module are loop modules, a module after the first module is the second module, and a module after the second module is the first module. For example, in response to the movement operation, the player controls the virtual character to complete a task of passing through the second module, and move from the end position of the second module to the start position of the first module.

Operation 340: Repeat at least one of the foregoing two operations until in a case that a loop end condition is met, the virtual character is controlled to move from the end position of the first module or the second module to a start position of a third module. In an example, the virtual character is controlled, by the processing circuitry and based on the second interaction operation, to move from the end position of the first instance of the second module to a start position of a third module of the level in the video game when the second condition of the second module is met and the loop end condition is met. For example, the virtual character is controlled to move to a plurality of instances of the first module and a plurality of instances of the second module until the loop end condition is met.

The loop end condition includes at least one of the following: the task in the level being completed, a duration in the first module or the second module reaching a first threshold, or a number of times of entering the first module or the second module reaching a second threshold.

For example, if the duration of the virtual character in the first module reaches the first threshold, that is, the loop end condition is met, and a module after the first module is the third module, the client controls the virtual character to move from the end position of the first module to the start position of the third module.

If the task in the level is completed when the virtual character is in the second module, that is, the loop end condition is met, and a module after the second module is the third module, the client controls the virtual character to move from the end position of the second module to the start position of the third module.

In conclusion, in the method provided in this aspect, the virtual character is controlled to move in the first module and the second module, so that the length of the level can be nearly infinite by loading only two modules by the client, and dynamic splicing adjustment can be performed according to the actual movement of the virtual character, thereby reducing performance pressure.

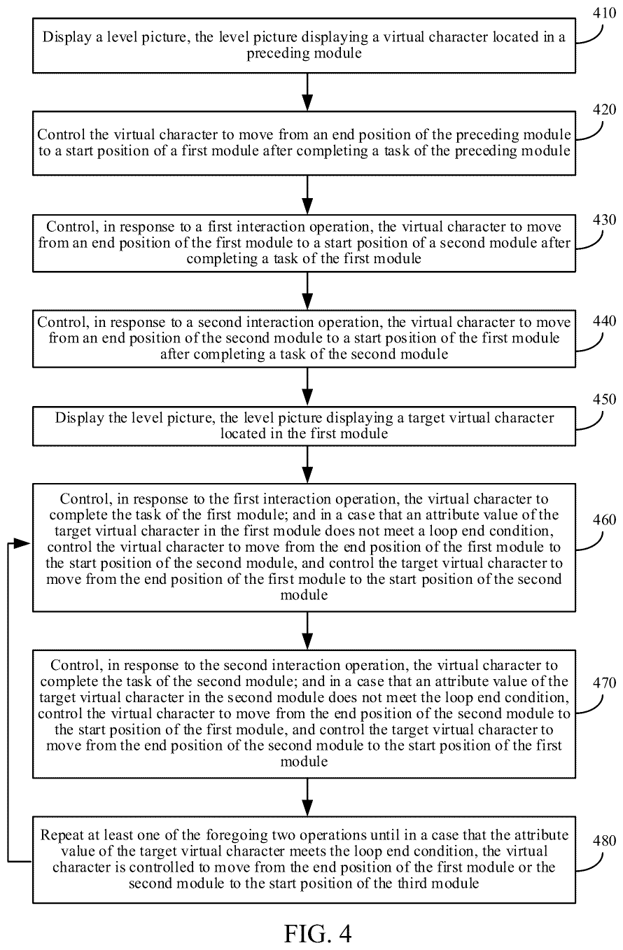

FIG. 4 is a flowchart of a level picture display method according to an example of an aspect of this disclosure. The method is performed by a client, for example. The method may further include at least one of the following operations 410 to 480.

Operation 410: Display a level picture, the level picture displaying a virtual character located in a preceding module.

A level is divided into a plurality of modules according to a logical relationship. The module is a minimum logic unit that can be run in a level, and includes at least one of the following: a line, a camera, a monster trigger, or a trigger.

A module type includes at least one of the following: an ordinary module or a loop module, where the ordinary module includes a scene resource that does not cyclically occur, and the loop module includes the same or similar scene resource that cyclically occurs. In this aspect, an example in which a first module and a second module are used as loop modules, and a preceding module and a third module are used as ordinary modules is used for description.

Operation 420: Control the virtual character to move from an end position of the preceding module to a start position of a first module after completing a task of the preceding module.

A trigger of the first module is set in the preceding module. When the virtual character is located in the preceding module, the trigger of the first module is triggered, and the client determines whether a loop condition is met. In a case that the loop condition is met, the client cyclically loads the first module and the second module, and the player cyclically displays the first module and the second module from the player perspective; and in a case that the loop condition is not met, the client loads the third module and does not start a loop. In this aspect, the loop condition is met, and the loop starts. The client controls the virtual character to move from the end position of the preceding module to the start position of the first module after completing the task of the preceding module.

Operation 430: Control, in response to a first interaction operation, the virtual character to move from an end position of the first module to a start position of a second module after completing a task of the first module.

The virtual character includes a game character controlled by a client/player and a game character controlled by a computer program. For example, in response to a movement operation, the player controls the virtual character to complete a task of passing through the first module and move from the end position of the first module to the start position of the second module.

Operation 440: Control, in response to a second interaction operation, the virtual character to move from an end position of the second module to a start position of the first module after completing a task of the second module.

Since the first module and the second module are loop modules, a module after the first module is the second module, and a module after the second module is the first module. For example, in response to the movement operation, the player controls the virtual character to complete a task for passing through the second module, and move from the end position of the second module to the start position of the first module.

Operation 450: Display the level picture, the level picture displaying a target virtual character located in the first module.

The target virtual character includes at least one of a monster, a teammate, or a virtual item in the level. According to different level design requirements, the target virtual character is set to different types. In this aspect, an example in which the target virtual character is a monster is used for description.

In some aspects, when the virtual character cyclically moves between the first module and the second module, the monster is displayed on the level picture. In some aspects, when the virtual character moves in the preceding module, the monster is displayed on the level picture, and after the monster is displayed, the virtual character cyclically moves between the first module and the second module.

Operation 460: Control, in response to the first interaction operation, the virtual character to complete the task of the first module; and in a case that an attribute value of the target virtual character in the first module does not meet a loop end condition, control the virtual character to move from the end position of the first module to the start position of the second module, and control the target virtual character to move from the end position of the first module to the start position of the second module.

In a case that the target virtual character is the monster, the attribute value of the target virtual character needs to decrease to a third threshold to complete the level, that is, the loop end condition is met. For example, in a case that the attribute value of the target virtual character in the first module does not decrease to the third threshold, the virtual character is controlled to move from the end position of the first module to the start position of the second module, and the target virtual character is controlled to move from the end position of the first module to the start position of the second module, where an attribute value of the target virtual character when the target virtual character appears in the second module inherits an attribute value of the target virtual character when the target virtual character leaves the first module.

In this aspect of this disclosure, a level length of a side-scrolling game is actually extended through repeated use of a loop module. The level is actually a linear continuous level. Therefore, as the game progresses, the attribute value of the target virtual character in the level is cumulative and continuous. That is, each time the game proceeds to a next module (for example, the second module), a virtual object in the next module needs to inherit an attribute value of the target virtual character in a previous module (for example, the first module), for example, inherit an attribute value of the target virtual character when the target virtual character leaves the previous module. For example, the attribute value may be a health value of the target virtual character. If the health value of the target virtual character is 55% when the target virtual character leaves the previous module, the health value of the target virtual character is 55% when the target virtual character just enters the next module.

In this aspect, when the target virtual character inherits the attribute value of the previous module when entering the next module, the level is not simply module repetition, but the attribute value of the target virtual object is continuously accumulated in a loop of the module, so that the virtual character has a continuous progression result during continuous advance in the level, which helps to weaken cyclical reciprocity of the module and helps to improve continuation and continuity of a level progression process.

Operation 470: Control, in response to the second interaction operation, the virtual character to complete the task of the second module; and in a case that an attribute value of the target virtual character in the second module does not meet the loop end condition, control the virtual character to move from the end position of the second module to the start position of the first module, and control the target virtual character to move from the end position of the second module to the start position of the first module.

In a case that the target virtual character is the monster, the attribute value of the target virtual character needs to decrease to a third threshold to complete the level, that is, the loop end condition is met. For example, in a case that the attribute value of the target virtual character in the second module does not decrease to the third threshold, the virtual character is controlled to move from the end position of the second module to the start position of the first module, and the target virtual character is controlled to move from the end position of the second module to the start position of the first module, where an attribute value of the target virtual character when the target virtual character appears in the first module inherits an attribute value of the target virtual character when the target virtual character leaves the second module.

In this aspect of this disclosure, a level length of a side-scrolling game is actually extended through repeated use of a loop module. The level is actually a linear continuous level. Therefore, as the game progresses, the attribute value of the target virtual character in the level is cumulative and continuous. That is, each time the game proceeds to a next module (for example, the first module), a virtual object in the next module needs to inherit an attribute value of the target virtual character in a previous module (for example, the second module), for example, inherit an attribute value of the target virtual character when the target virtual character leaves the previous module. For example, the attribute value may be a health value of the target virtual character. If the health value of the target virtual character is 55% when the target virtual character leaves the previous module, the health value of the target virtual character is 55% when the target virtual character just enters the next module.

In this aspect, when the target virtual character inherits the attribute value of the previous module when entering the next module, the level is not simply module repetition, but the attribute value of the target virtual object is continuously accumulated in a loop of the module, so that the virtual character has a continuous progression result during continuous advance in the level, which helps to weaken cyclical reciprocity of the module and helps to improve continuation and continuity of a level progression process.

Operation 480: Repeat at least one of the foregoing two operations until in a case that the attribute value of the target virtual character meets the loop end condition, the virtual character is controlled to move from the end position of the first module or the second module to the start position of the third module.

The loop end condition includes at least one of the following: a duration in the first module or the second module reaching a first threshold, or a number of times of entering the first module or the second module reaching a second threshold, or the attribute value of the target virtual character decreasing to a third threshold. For example, if when the virtual character is in the second module, the attribute value of the target virtual character decreases to the third threshold, that is, the loop end condition is met, and a module after the second module is the third module, the client controls the virtual character to move from the end position of the second module to the start position of the third module.

In some aspects, operation 480 includes: Repeat at least one of the foregoing two operations until a duration of the virtual character in the first module and/or the second module meets the loop end condition, the virtual character is controlled to move from the end position of the first module or the second module to the start position of the third module.

In this case, whether to end the loop is independent of the attribute value of the target virtual character. For example, in a case that the duration of the virtual character in the first module reaches the first threshold, that is, the loop end condition is met, the client controls the virtual character to move from the end position of the first module to the start position of the third module.

In conclusion, in the method provided in this aspect, the virtual character is controlled to move cyclically in the first module and the second module, and the target virtual character moves along with the virtual character. In a case that the attribute value of the target virtual character decreases to the third threshold, that is, the loop end condition is met, the virtual character is controlled to move to the third module, so that the length of the level can be nearly infinite by loading only two modules by the client, and dynamic splicing adjustment can be performed according to the actual movement of the virtual character, thereby reducing performance pressure.

In the method provided in this aspect, the virtual character is further controlled to move cyclically in the first module and the second module, and in a case that the duration of the virtual character in the first module and/or the second module reaches the loop end condition, the virtual character is controlled to move to the third module, so that the length of the level can be nearly infinite by loading only two modules by the client, and dynamic splicing adjustment can be performed according to the actual movement of the virtual character, thereby reducing the performance pressure.

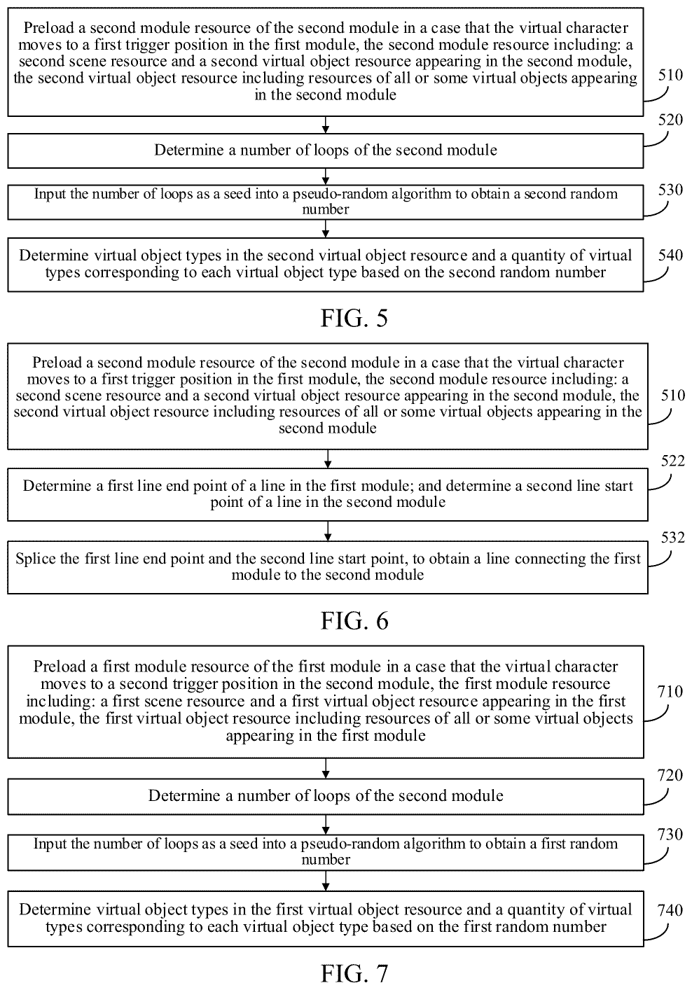

FIG. 5 is a flowchart of a level picture display method according to an example of an aspect of this disclosure. The method is performed by a client, for example. The method may further include at least one of the following operations 510 to 540.

Operation 510: Preload a second module resource of the second module in a case that the virtual character moves to a first trigger position in the first module, the second module resource including: a second scene resource and a second virtual object resource appearing in the second module, the second virtual object resource including resources of all or some virtual objects appearing in the second module.

To avoid a situation in which the module resources have not been displayed after the virtual character moves to the module, the client preloads the second module resource in the second module in a case that the virtual character moves to the first trigger position in the first module. The resources of some virtual objects in the second module resource include resources with less performance pressure, such as a logical relationship and a background picture.

In this aspect, resources of a next module are preloaded when the virtual character has not moved to the next module, thereby avoiding the situation in which the resources of the module have not been displayed after the virtual character moves to the module, and improving display efficiency of the level picture.

Operation 520: Determine a number of loops of the second module.

The second module is used as a loop module, and the client records the number of loops of the second module. In the method, the client retrieves the record to determine the number of loops of the second module.

Operation 530: Input the number of loops as a seed into a pseudo-random algorithm to obtain a second random number.

The number of loops of the second module is used as an input value, and the second random number is obtained by using the pseudo-random algorithm.

The pseudo-random algorithm is a random generation algorithm based on a fixed random table. Such a random algorithm returns a random number. Its characteristic is that after a program is initialized, a random value generated by calling the algorithm a few times is determined. For example, if the pseudo-random algorithm is called for the first time, the pseudo-random algorithm returns 1, and if the pseudo-random algorithm is called for the second time, the pseudo-random algorithm returns 0. After the program is initialized, the pseudo-random algorithm is called again. If the pseudo-random algorithm is called for the first time, the pseudo-random algorithm also needs to return 1, and if the pseudo-random algorithm is called for the second time, the pseudo-random algorithm needs to return 0.

Operation 540: Determine virtual object types in the second virtual object resource and a quantity of virtual objects corresponding to each virtual object type based on the second random number.

Content in the second virtual object resource is determined based on the second random number, so that the related content can be displayed in various manners, which brings uncertainty, and the content in the modules of the infinite loop is not the same. A virtual object type includes: at least one of a monster, an equipment, an item, or a trap. For example, the second random number is 32114112, where 32 represents three monsters of a second monster type, 11 represents an equipment of a first equipment type, 41 represents four items of a first item type, and 12 represents a trap of a second trap type.

In some aspects, a position at which the virtual object in the second virtual object resource is displayed may further be determined based on the second random number. For example, the second random number is 322114413121, where 322 represents that the three monsters of the second monster type are displayed at a second position, 114 represents that the equipment of the first equipment type is displayed at a fourth position, 413 represents that the four items of the first item type are displayed at a third position, and 121 represents that the trap of the second trap type is displayed at a first position.

In some aspects, the content in the second scene resource is determined in the same implementation method, and the related content is displayed in various manners. Implementation principles are the same. Details are not described herein again.

In conclusion, in the method provided in this aspect, the second module resource is determined based on the random number, so that module repetition is reduced while performance pressure is reduced.

FIG. 6 is a flowchart of a level picture display method according to an example of an aspect of this disclosure. The method is performed by a client. The method may further include at least one of the following operations 510 to 532.

Operation 510: Preload a second module resource of the second module in a case that the virtual character moves to a first trigger position in the first module, the second module resource including: a second scene resource and a second virtual object resource appearing in the second module, the second virtual object resource including resources of all or some virtual objects appearing in the second module.

Operation 522: Determine a first line end point of a line in the first module; and determine a second line start point of a line in the second module.

In the side-scrolling virtual environment, an activity space of the virtual character is limited. The virtual character can only move along a preset movement line, and the movement line is referred to as a line for short. Usually, the line is along a horizontal direction. In some cases, the line may be two floors or three floors, for example, a scene in which a bridge or a high platform exists. In some cases, the line may be oblique or vertical, such as a scene in which a slope or a cliff exists. In some aspects, the line may also be a plane on which the line is located. The plane is perpendicular to a horizontal plane of the side-scrolling virtual environment. In some aspects, the line may also be referred to as a movable path of the virtual character in the side-scrolling virtual environment.

In this aspect, the virtual character needs to move from the first module to the second module. A point at which movement starts on the line is a line start point, and a point at which movement ends on the line is a line end point. Therefore, the first line end point of the line in the first module is determined, and the second line start point of the line in the second module is determined. In some aspects, the first line end point is a point at which movement ends on the line in the first module, and the second line start point is a point at which movement starts on the line in the second module. In some aspects, the first line end point is an end point of the line of the first module, and the second line start point is a start point of the line of the second module.

Operation 532: Splice the first line end point and the second line start point, to obtain a line connecting the first module to the second module.

The line connecting the first module to the second module is obtained by splicing the first line end point and the second line start point, so that the virtual character can move coherently from the first module to the second module. The line includes at least one of a line for the virtual character to move along a horizontal direction, a line for the virtual character to jump upward, or a line for the virtual character to jump downward.

In conclusion, in the method provided in this aspect, through the line connecting the first module to the second module, the virtual character can move coherently from the first module to the second module, thereby ensuring a coherent experience.

FIG. 7 is a flowchart of a level picture display method according to an example of an aspect of this disclosure. The method is performed by a client, for example. The method may further include at least one of the following operations 710 to 740.

Operation 710: Preload a first module resource of the first module in a case that the virtual character moves to a second trigger position in the second module, the first module resource including: a first scene resource and a first virtual object resource appearing in the first module, the first virtual object resource including resources of all or some virtual objects appearing in the first module.

To avoid a situation in which the module resources have not been displayed after the virtual character moves to the module, the client preloads the first module resource in the first module in a case that the virtual character moves to the second trigger position in the second module. The resources of some virtual objects in the first module resource include resources with less performance pressure, such as a logical relationship and a background picture.

In this aspect, resources of a next module are preloaded when the virtual character has not moved to the next module, thereby avoiding the situation in which the resources of the module have not been displayed after the virtual character moves to the module, and improving display efficiency of the level picture.

Operation 720: Determine a number of loops of the first module.

The first module is used as a loop module, and the client records the number of loops of the first module. In the method, the client retrieves the record to determine the number of loops of the first module.

Operation 730: Input the number of loops as a seed into a pseudo-random algorithm to obtain a first random number.

The number of loops of the first module is used as an input value, and the first random number is obtained by using the pseudo-random algorithm.

The pseudo-random algorithm is a random generation algorithm based on a fixed random table. Such a random algorithm returns a random number. Its characteristic is that after a program is initialized, a random value generated by calling the algorithm a few times is determined. For example, if the pseudo-random algorithm is called for the first time, the pseudo-random algorithm returns 1, and if the pseudo-random algorithm is called for the second time, the pseudo-random algorithm returns 0. After the program is initialized, the pseudo-random algorithm is called again. If the pseudo-random algorithm is called for the first time, the pseudo-random algorithm also needs to return 1, and if the pseudo-random algorithm is called for the second time, the pseudo-random algorithm needs to return 0.

Operation 740: Determine virtual object types in the first virtual object resource and a quantity of virtual objects corresponding to each virtual object type, based on the first random number.

Content in the first virtual object resource is determined based on the first random number, so that the related content can be displayed is various manners, which brings uncertainty, and the content in the modules of the infinite loop is not the same. A virtual object type includes: at least one of a monster, an equipment, an item, or a trap.

For example, the first random number is 32114112, where 32 represents three monsters of a second monster type, 11 represents an equipment of a first equipment type, 41 represents four items of a first item type, and 12 represents a trap of a second trap type.

In some aspects, a position at which the virtual object in the first virtual object resource is displayed may further be determined based on the first random number. For example, the first random number is 322114413121, where 322 represents that the three monsters of the second monster type are displayed at a second position, 114 represents that the equipment of the first equipment type is displayed at a fourth position, 413 represents that the four items of the first item type are displayed at a third position, and 121 represents that the trap of the second trap type is displayed at a first position.

In some aspects, the content in the first scene resource is determined in the same implementation method, and the related content is displayed in various manners. Implementation principles are the same. Details are not described herein again.

In conclusion, in the method provided in this aspect, the first module resource is determined based on the random number, so that module repetition is reduced while performance pressure is reduced.

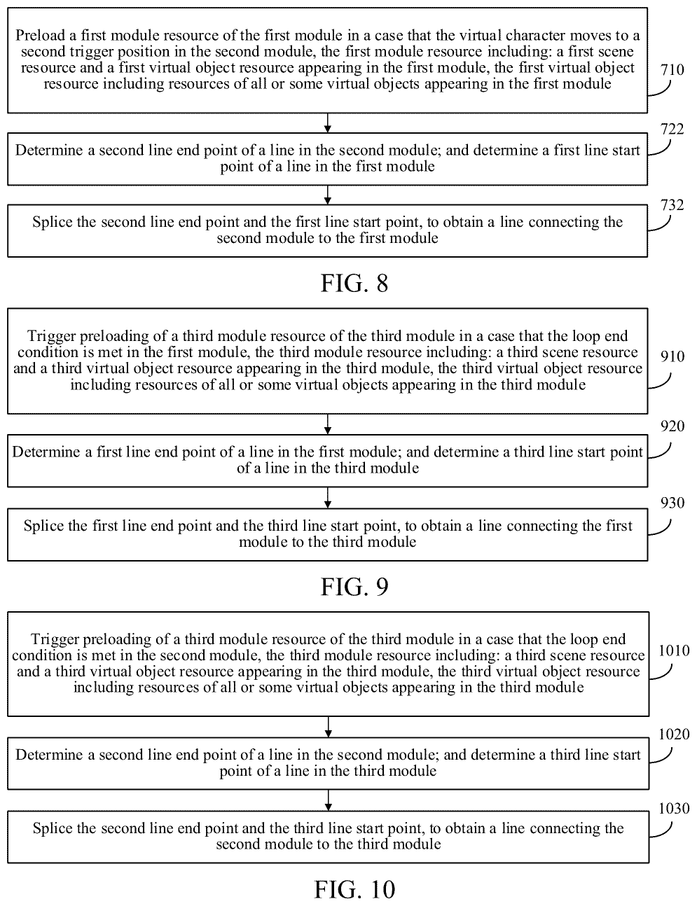

FIG. 8 is a flowchart of a level picture display method according to examples of aspects of this disclosure. The method is performed by a client, for example. The method may further include at least one of the following operations 710 to 732.

Operation 710: Preload a first module resource of the first module in a case that the virtual character moves to a second trigger position in the second module, the first module resource including: a first scene resource and a first virtual object resource appearing in the first module, the first virtual object resource including resources of all or some virtual objects appearing in the first module.

Operation 722: Determine a second line end point of a line in the second module; and determine a first line start point of a line in the first module.

In the side-scrolling virtual environment, an activity space of the virtual character is limited. The virtual character can only move along a preset movement line, and the movement line is referred to as a line for short. Usually, the line is along a horizontal direction. In some cases, the line may be two floors or three floors, for example, a scene in which a bridge or a high platform exists. In some cases, the line may be oblique or vertical, such as a scene in which a slope or a cliff exists. In some aspects, the line may also be a plane on which the line is located. The plane is perpendicular to a horizontal plane of the side-scrolling virtual environment. In some aspects, the line may also be referred to as a movable path of the virtual character in the side-scrolling virtual environment.

In this aspect, the virtual character needs to move from the second module to the first module. A point at which movement starts on the line is a line start point, and a point at which movement ends on the line is a line end point. Therefore, the second line end point of the line in the second module is determined, and the first line start point of the line in the first module is determined.

In some aspects, the second line end point is a point at which movement ends on the line in the second module, and the first line start point is a point at which movement starts on the line in the first module. In some aspects, the second line end point is an end point of the line of the second module, and the first line start point is a start point of the line of the first module.

Operation 732: Splice the second line end point and the first line start point, to obtain a line connecting the second module to the first module.

The line connecting the second module to the first module is obtained by splicing the second line end point and the first line start point, so that the virtual character can move coherently from the second module to the first module. The line includes at least one of a line for the virtual character to move along a horizontal direction, a line for the virtual character to jump upward, or a line for the virtual character to jump downward.

In conclusion, in the method provided in this aspect, through the line connecting the first module to the second module, the virtual character can move coherently from the second module to the first module, thereby ensuring a coherent experience.

FIG. 9 is a flowchart of a level picture display method according to an example of an aspect of this disclosure. The method is performed by a client, for example. The method may further include at least one of the following operations 910 to 930.

Operation 910: Trigger preloading of a third module resource of the third module in a case that the loop end condition is met in the first module, the third module resource including: a third scene resource and a third virtual object resource appearing in the third module, the third virtual object resource including resources of all or some virtual objects appearing in the third module.

In a case that the loop end condition is met in the first module, a module after the first module is the third module. To avoid a situation in which the module resources have not been displayed after the virtual character moves to the third module, the client preloads the third module resource in the third module. The resources of some virtual objects in the third module resource include resources with less performance pressure, such as a logical relationship and a background picture.

Operation 920: Determine a first line end point of a line in the first module; and determine a third line start point of a line in the third module.

In the side-scrolling virtual environment, an activity space of the virtual character is limited. The virtual character can only move along a preset movement line, and the movement line is referred to as a line for short. In this aspect, the virtual character needs to move from the first module to the third module. A point at which movement starts on the line is a line start point, and a point at which movement ends on the line is a line end point. Therefore, the first line end point of the line in the first module is determined, and the third line start point of the line in the third module is determined.

In some aspects, the third line start point is a point at which movement starts on the line of the third module. In some aspects, the third line start point is a start point of the line of the third module.

Operation 930: Splice the first line end point and the third line start point, to obtain a line connecting the first module to the third module.

The line connecting the first module to the third module is obtained by splicing the first line end point and the third line start point, so that the virtual character can move coherently from the first module to the third module. The line includes at least one of a line for the virtual character to move along a horizontal direction, a line for the virtual character to jump upward, or a line for the virtual character to jump downward.

In conclusion, in the method provided in this aspect, the third module resource of the third module is triggered to be preloaded in a case that the loop end condition is met in the first module, thereby avoiding a problem that the module resources have not been displayed after the virtual character moves to the third module, and ensuring a coherent experience.

In the method provided in this aspect, through the line connecting the first module to the third module, the virtual character can further move coherently from the first module to the third module, thereby ensuring the coherent experience.

FIG. 10 is a flowchart of a level picture display method according to an example of an aspect of this disclosure. The method is performed by a client, for example. The method may further include at least one of the following operations 1010 to 1030.

Operation 1010: Trigger preloading of a third module resource of the third module in a case that the loop end condition is met in the second module, the third module resource including: a third scene resource and a third virtual object resource appearing in the third module, the third virtual object resource including resources of all or some virtual objects appearing in the third module.

In a case that the loop end condition is met in the second module, a module after the second module is the third module. To avoid a situation in which the module resources have not been displayed after the virtual character moves to the third module, the client preloads the third module resource in the third module. The resources of some virtual objects in the third module resource include resources with less performance pressure, such as a logical relationship and a background picture.

Operation 1020: Determine a second line end point of a line in the second module; and determine a third line start point of a line in the third module.

In the side-scrolling virtual environment, an activity space of the virtual character is limited. The virtual character can only move along a preset movement line, and the movement line is referred to as a line for short. In this aspect, the virtual character needs to move from the second module to the third module. A point at which movement starts on the line is a line start point, and a point at which movement ends on the line is a line end point. Therefore, the second line end point of the line in the second module is determined, and the third line start point of the line in the third module is determined.

In some aspects, the second line end point is a point at which movement ends on the line of the second module. In some aspects, the third line start point is a start point of the line of the third module.

Operation 1030: Splice the second line end point and the third line start point, to obtain a line connecting the second module to the third module.

The line connecting the second module to the third module is obtained by splicing the second line end point and the third line start point, so that the virtual character can move coherently from the second module to the third module. The line includes at least one of a line for the virtual character to move along a horizontal direction, a line for the virtual character to jump upward, or a line for the virtual character to jump downward.

In conclusion, in the method provided in this aspect, the third module resource of the third module is triggered to be preloaded in a case that the loop end condition is met in the second module, thereby avoiding a problem that the module resources have not been displayed after the virtual character moves to the third module, and ensuring a coherent experience.

In the method provided in this aspect, through the line connecting the second module to the third module, the virtual character can further move coherently from the second module to the third module, thereby ensuring the coherent experience.

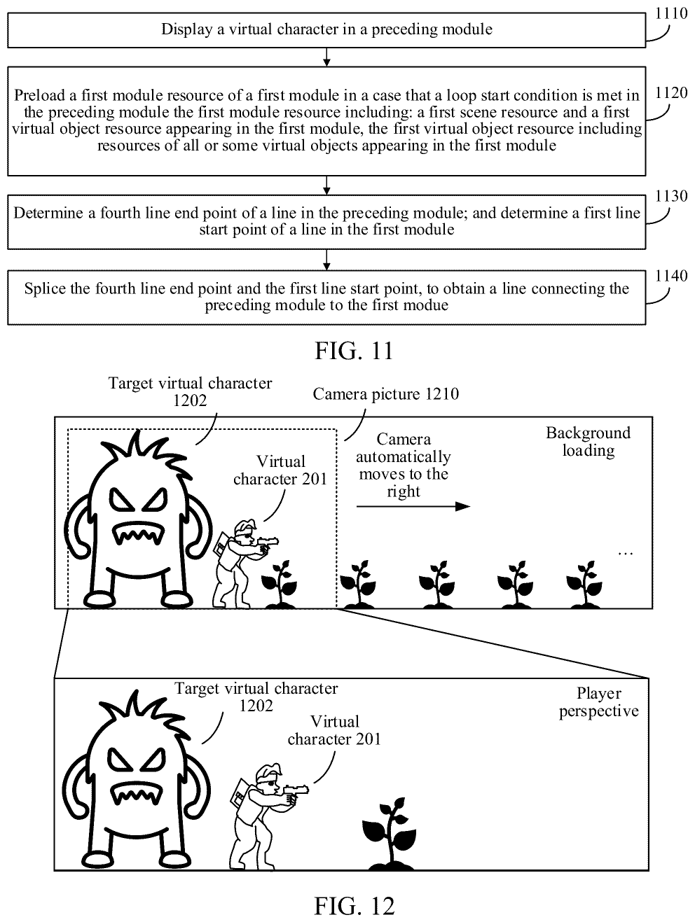

FIG. 11 is a flowchart of a level picture display method according to an example of an aspect of this disclosure. The method is performed by a client, for example. The method may further include at least one of the following operations 1110 to 1140.

Operation 1110: Display a virtual character in a preceding module.

A level is divided into a plurality of modules according to a logical relationship. The module is a minimum logic unit that can be run in a level, and includes at least one of the following: a line, a camera, a monster trigger, or a trigger.

A module type includes at least one of the following: an ordinary module or a loop module, where the ordinary module includes a scene resource that does not cyclically occur, and the loop module includes the same or similar scene resource that cyclically occurs. In this aspect, an example in which a first module is used as a loop module and a preceding module is used as an ordinary module is used for description.

Operation 1120: Preload a first module resource of a first module in a case that a loop start condition is met in the preceding module, the first module resource including: a first scene resource and a first virtual object resource appearing in the first module, the first virtual object resource including resources of all or some virtual objects appearing in the first module.

In a case that the loop start condition is met in the preceding module, a module after the preceding module is the first module. To avoid a situation in which the module resources have not been displayed after the virtual character moves to the first module, the client preloads the first module resource in the first module. The resources of some virtual objects in the first module resource include resources with less performance pressure, such as a logical relationship and a background picture.

Operation 1130: Determine a fourth line end point of a line in the preceding module; and determine a first line start point of a line in the first module.

In the side-scrolling virtual environment, an activity space of the virtual character is limited. The virtual character can only move along a preset movement line, and the movement line is referred to as a line for short. In this aspect, the virtual character needs to move from the preceding module to the first module. A point at which movement starts on the line is a line start point, and a point at which movement ends on the line is a line end point. Therefore, the fourth line end point of the line in the preceding module is determined, and the first line start point of the line in the first module is determined.

In some aspects, the fourth line end point is a point at which movement ends on the line of the preceding module. In some aspects, the fourth line end point is an end point of the line of the preceding module.

Operation 1140: Splice the fourth line end point and the first line start point, to obtain a line connecting the preceding module to the first module.

The line connecting the preceding module to the first module is obtained by splicing the fourth line end point and the first line start point, so that the virtual character can move coherently from the preceding module to the first module. The line includes at least one of a line for the virtual character to move along a horizontal direction, a line for the virtual character to jump upward, or a line for the virtual character to jump downward.

In conclusion, in the method provided in this aspect, the first module resource of the first module is preloaded in a case that the loop start condition is met in the preceding module, thereby avoiding a problem that the module resources have not been displayed after the virtual character moves to the first module, and ensuring a coherent experience.

In the method provided in this aspect, through the line connecting the preceding module to the first module, the virtual character can further move coherently from the preceding module to the first module, thereby ensuring the coherent experience.

FIG. 12 is a schematic diagram of a level picture display method in the related art. The method is performed by a client. FIG. 12 includes: a virtual character 201, a target virtual character 1202, and a camera picture 1210. The camera picture 1210 is acquired by a camera module arranged in the client. The camera module moves from left to right following the virtual character 201. The camera picture 1210 is acquired during the movement, and is displayed as a player perspective shown in the figure.

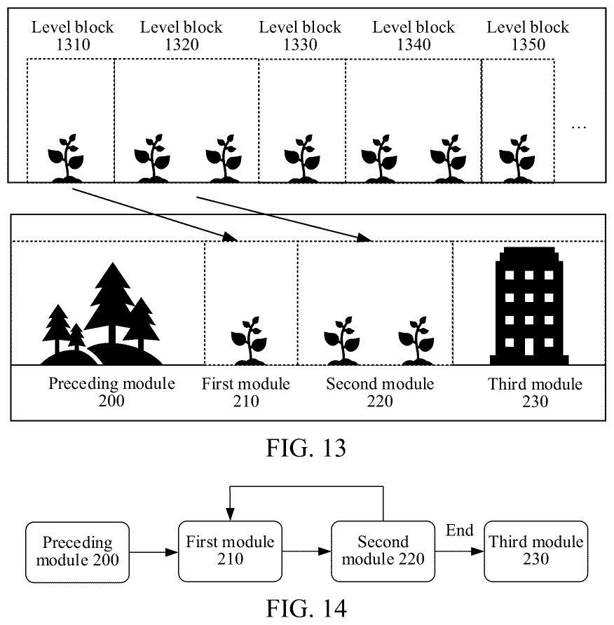

In the player perspective, the target virtual character 1202 continuously chases the virtual character 201, and the virtual character 201 needs to continuously move. The chase process usually lasts for a specific duration. Therefore, in the related art, a level part used in the chase process is set to repeated content. As shown in FIG. 13, the level part through which the virtual character 201 passes in the chase process includes: a level block 1310, a level block 1320, a level block 1330, a level block 1340, a level block 1350, and the like. The level block 1310, the level block 1330, and the level block 1350 are the same level block, and the level block 1320 and the level block 1340 are the same level block. The client continuously loads repeated level blocks subsequently, which has high performance requirements on a terminal device supporting the client. In addition, the level blocks need to be arranged and maintained. The quality of the level blocks cannot be ensured in the process, and high maintenance costs are incurred.

Therefore, as shown in FIG. 13, FIG. 13 is a schematic diagram of a level picture display method according to an example of an aspect of this disclosure. In the method, repeated level blocks are set as modules, and repeated modules are cyclically loaded by a program. A level includes N modules connected end to end, and N is a positive integer. The level block 1310 is set as the first module 210, and the level block 1320 is set as the first module 210. The first module 210 is preceded by the preceding module 200, and the second module 220 is followed by the third module 230. As shown in FIG. 14, during the game of the player, the client loads the first module 210 after loading the preceding module 200, and then loads the second module 220. In a case that the player does not complete a current level, after loading the second module 220, the client cyclically loads the first module 210 and the second module 220, thereby forming an infinitely cyclical level. In a case that the player completes the current level, the client loads the third module 230 after loading the second module 220, and the loop ends.

In conclusion, in the method provided in this aspect, by cyclically loading the first module and the second module, the virtual character is controlled to move in the first module and the second module, so that the length of the level can be nearly infinite by loading only two modules by the client, and dynamic splicing adjustment can be performed according to the actual movement of the virtual character, thereby reducing performance pressure.

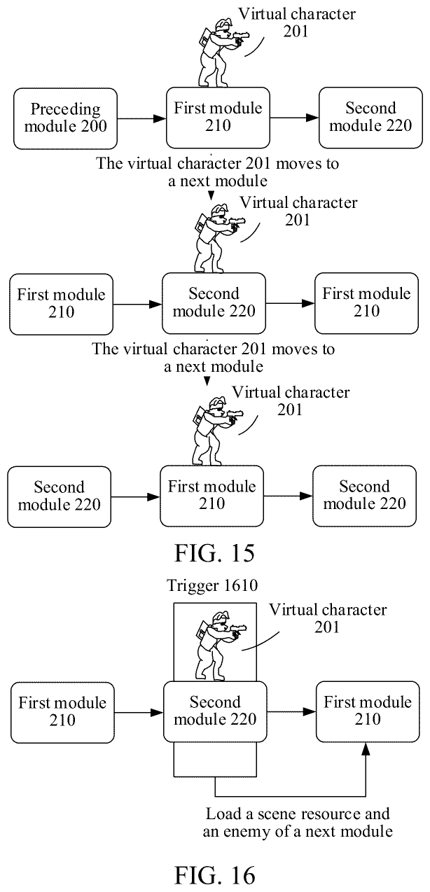

FIG. 15 is a schematic diagram of a level picture display method according to an example of an aspect of this disclosure. The method is performed by a client to dynamically load and splice the first module 210 and the second module 220 according to a position of the virtual character 201. As shown in the figure, when the virtual character 201 is in the first module 210, the client loads the second module 220 and splices the second module 220 and the first module 210;

when the virtual character 201 moves to a next module, that is, moves to the second module 220, the client loads the first module 210 and splices the first module 210 and the second module 220; and

when the virtual character 201 moves to a next module, that is, moves to the first module 210, the client loads the second module 220 and splices the second module 220 and the first module 210.

By analogy, an infinite loop may be performed to form a level of an infinite length, and a module is loaded or unloaded according to the position of the virtual character 201, to ensure a specific quantity of modules running at the same time, thereby reducing performance pressure.

However, to avoid a situation in which the scene resources and the monsters have not been loaded after the virtual character 201 moves to the module, the client needs to preload scene resources and monsters of a next module, and a trigger of each module is set in a previous module. As shown in FIG. 16, FIG. 16 is a schematic diagram of a level picture display method according to an example of an aspect of this disclosure. After the virtual character 201 moves to the second module 220, a trigger 1610 of a next first module 210 is triggered. In this case, the client preloads scene resources and monsters in the first module 210, so that the two modules can be seamlessly connected.

In conclusion, in the method provided in this aspect, by cyclically loading the first module and the second module, the virtual character is controlled to move in the first module and the second module, so that the length of the level can be nearly infinite by loading only two modules by the client, and dynamic splicing adjustment can be performed according to the actual movement of the virtual character, thereby reducing performance pressure.

In the method provided in this aspect, the scene resources and the monsters of a next module are further preloaded when a trigger of the next module is triggered, which avoids a problem that the scene resources and the monsters have not been displayed after the virtual character moves to the next module, thereby ensuring a coherent experience.

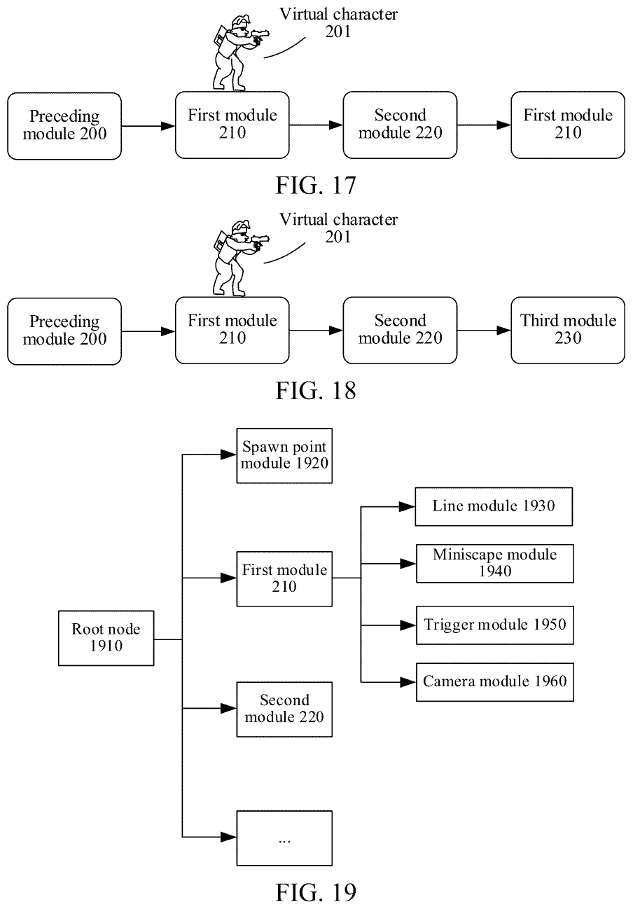

Since other modules exist before and after the loop module, the client needs to instruct the program to start a loop in a case that the loop start condition is met, and continue to load a subsequent ordinary module in a case that the loop start condition is not met, to determine whether to load a loop module or a subsequent ordinary module after loading the loop module. As shown in FIG. 17, FIG. 17 is a schematic diagram of a level picture display method according to an example of an aspect of this disclosure. When the virtual character 201 moves to the first module 210 and the loop start condition is met, the client instructs the program to start a loop, that is, loads and splices the first module 210 after the second module 220, and the loop starts.

As shown in FIG. 18, FIG. 18 is a schematic diagram of a level picture display method according to an example of an aspect of this disclosure. When the virtual character 201 moves to the first module 210 and the loop start condition is not met, the client does not instruct the program to start a loop, and the client loads the third module 230 and splices the second module 220.

When the loop end condition is met, the client instructs the program to end the loop; and when the loop end condition is not met, the client does not instruct the program to end the loop. As shown in FIG. 18, when the virtual character 201 completes the level, the loop end condition is met. The client instructs the program to end the loop, and the client loads the third module 230 and splices the second module 220.

As shown in FIG. 17, when the virtual character 201 does not complete the level, the loop end condition is not met, and the client does not notify the program to end the loop, that is, loads and splices the first module 210 after the second module 220, and continues the loop.

In conclusion, in the method provided in this aspect, in a case that the loop start condition is met or the loop end condition is not met, by cyclically loading the first module and the second module, the virtual character is controlled to move in the first module and the second module, so that the length of the level can be nearly infinite by loading only two modules by the client, and dynamic splicing adjustment can be performed according to the actual movement of the virtual character, thereby reducing performance pressure.

In the method provided in this aspect, in a case that the loop end condition is met or the loop start condition is not met, the third module is further loaded after the first module and the second module, so that scalability of the level is improved.

In this disclosure, a level is divided into a plurality of modules according to a logical relationship. The module is a smallest logical unit that can be run in a level, and includes at least one of a line module, a miniscape module, a trigger module, or a camera module. A level may include a plurality of modules. Each module is an instance in a scene. The level can store a basic module and reference a module. FIG. 19 is a schematic structural diagram of module information according to an example of an aspect of this disclosure. The module information includes:
a root node 1910, having a plurality of subnodes, including: at least one of a spawn point module 1920, a first module 210, or a second module 220.

The spawn point module 1920 is configured to record information about a spawn location of the virtual character in the client.

The loop module includes a plurality of modules. The first module 210 is used as an example for description. The first module 210 includes at least one of the following: a line module 1930, a miniscape module 1940, a trigger module 1950, or a camera module 1960.

The line module 1930 is a configuration related to wayfinding of a virtual character and a monster, and includes a wayfinding line and a moving hitbox. The wayfinding line is a basis for wayfinding calculation and route planning of the virtual character and the monster, and the moving hitbox determines a hit relationship between the virtual character and the monster and the ground.

The miniscape module 1940 records a monster trigger and monster information related to the battle. The monster trigger is a trigger. When the virtual character moves into a trigger range, a configured monster is displayed. The monster information includes a behavior, a value, an operation logic, and the like of the monster.

The trigger module 1950 records other trigger information related to the module, such as a trigger event and trigger background music information.

The camera module 1960 records information about a camera related to the module, including information about a camera trigger and camera blocking frame. The camera trigger is a trigger for changing camera parameters. When the virtual character enters the trigger range, the camera parameters such as a camera position, a camera distance, and a camera movement speed may be changed. The camera blocking frame is a configuration for blocking the camera movement, and is an artificially specified region. When a boundary of the camera of the virtual character hits a boundary of the blocking frame, the blocking frame blocks the camera movement of the virtual character.

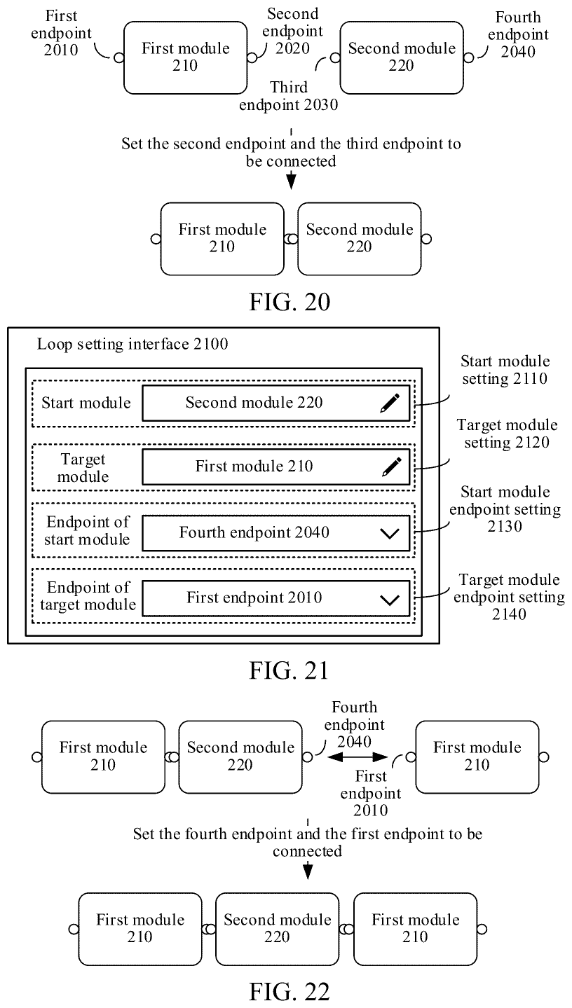

Although the module records all information of the level through the foregoing modules, the program does not understand a position relationship between the modules. The position relationship between the modules is determined by a connection relationship among positions of endpoints, that is, positions of the modules are relative. As long as two modules are in a connection relationship, a position of the latter module changes with a position of the previous module, to ensure connection between the two modules. Therefore, a splicing relationship between the modules can be determined by determining two endpoints on the module, and setting the connection relationship between the endpoints on the module, to further determine the position of the module. As shown in FIG. 20, FIG. 20 is a schematic diagram of a module splicing method according to an example of an aspect of this disclosure, including: a first module 210 and a second module 220, where a first endpoint 2010 and a second endpoint 2020 are determined on the first module 210, and a third endpoint 2030 and a fourth endpoint 2040 are determined on the second module 220. By setting the second endpoint 2020 and the third endpoint 2030 to be connected, a relative position relationship between the first module 210 and the second module 220 is determined. In other words, a position at which the second module 220 is loaded is behind a position at which the first module 210 is loaded.

To implement the foregoing method, the module and the endpoint need to be set. As shown in FIG. 21, FIG. 21 is a schematic diagram of a loop setting interface 2100 according to an example of an aspect of this disclosure. The loop setting interface 2100 includes at least one of the following: start module setting 2110, target module setting 2120, start module endpoint setting 2130, and target module endpoint setting 2140. The start module setting 2110 and the target module setting 2120 are set by clicking on a stylus interaction key at the right side, and the start module endpoint setting 2130 and the target module endpoint setting 2140 are set by clicking on a pull-down interaction key at the right side.

To implement the method provided in this disclosure, a start module and a target module need to be set, and setting an endpoint splicing relationship is setting an endpoint of the start module and an endpoint of the target module. When the loop starts, the program determines a loading position of the module according to a set endpoint.

For example, the start module is set to the second module 220, the target module is set to the first module 210, the endpoint of the start module is set to the fourth endpoint 2040, and the endpoint of the target module is set to the first endpoint 2010. A splicing method after setting is shown in FIG. 22. FIG. 22 is a schematic diagram of a module splicing method according to an example of an aspect of this disclosure. According to the foregoing setting, the fourth endpoint 2040 is connected to the first endpoint 2010. Through the positions of the fourth endpoint 2040 and the first endpoint 2010, the first module 210 is loaded after the second module 220 is determined.

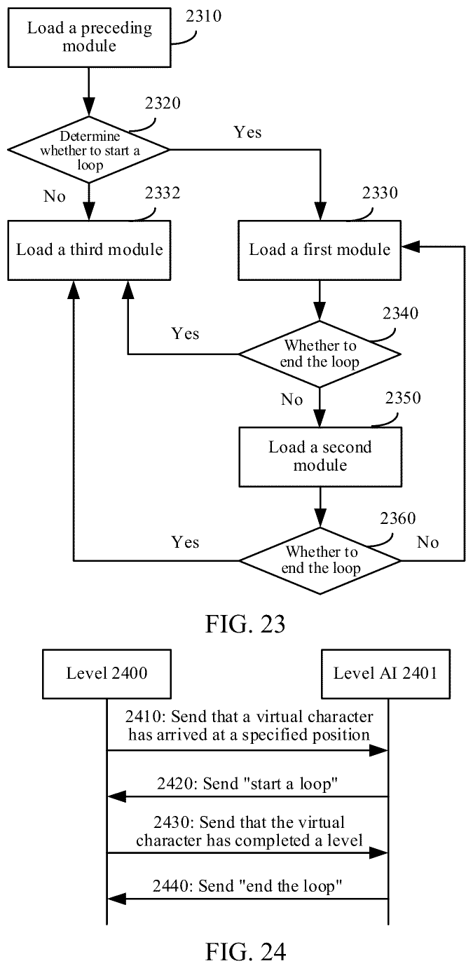

Since an ordinary module may be spliced before and after the loop module, the timing for the loop module to start and end a loop needs to be controlled according to a level design requirement. The loop module includes the first module and the second module. Therefore, two solutions: a trigger script and an artificial intelligence (AI) script, are provided, to control, according to the level design requirement, the timing for the loop module to start and end a loop. The trigger script solution is shown in FIG. 23. FIG. 23 is a flowchart of a level picture display method according to an example of an aspect of this disclosure. The method is performed by a client. The method may include at least one of the following operations 2310 to 2360.

Operation 2310: Load a preceding module.

The client loads the preceding module. The preceding module is an ordinary module that is not a loop module.

Operation 2320: Determine whether to start a loop.

The client determines whether to start the loop, and performs operation 2330 in a case that the loop start condition is met; and performs operation 2332 in a case that the loop start condition is not met. For example, in a case that there is an infinitely long level design requirement in the current level, the loop start condition is met, and operation 2330 is performed; and in a case that there is no infinitely long level design requirement in the current level, the loop start condition is not met, and operation 2332 is performed.

Operation 2330: Load a first module.

The client loads the first module in a case that the loop start condition is met, and the first module is a loop module.

Operation 2332: Load a third module.

The client loads the third module in a case that the loop start condition is not met, and the third module is an ordinary module that is not a loop module.

Operation 2340: Determine whether to end the loop.

The client determines whether to end the loop, and performs operation 2332 in a case that the loop end condition is met; and performs operation 2350 in a case that the loop end condition is not met. For example, in a case that all monsters in the level are defeated, the loop end condition is met and operation 2332 is performed; and in a case that all monsters in the level are not defeated, the loop end condition is not met, and operation 2350 is performed.

Operation 2350: Load a second module.

The client loads the second module in a case that the loop start condition is met, and the second module is a loop module.

Operation 2360: Determine whether to end the loop.

The client determines whether to end the loop, and performs operation 2332 in a case that the loop end condition is met; and performs operation 2330 in a case that the loop end condition is not met. For example, in a case that all monsters in the level are defeated, the loop end condition is met and operation 2332 is performed; and in a case that all monsters in the level are not defeated, the loop end condition is not met, and operation 2330 is performed.

The AI script solution is shown in FIG. 24. FIG. 24 is a flowchart of a level picture display method according to an example of an aspect of this disclosure. The method is performed by a level 2400 and a level AI 2401. The level AI 2401 is a general control AI of the level 2400 and is responsible for receiving an event occurring in the level 2400 and sending a control instruction. The method may include at least one of the following operations 2410 to 2440.

Operation 2410: A level sends that a virtual character has arrived at a specified position.

When the virtual character triggers a trigger in the module, the level 2400 sends a message to the level AI 2401 that the virtual character has arrived at the specified position. For example, the virtual character moves to the preceding module, the trigger of the first module is triggered in the preceding module, and the level 2400 sends the message to the level AI 2401 that the virtual character has arrived at the specified position.

Operation 2420: A level AI sends “start a loop”.

After receiving the message that the virtual character has arrived at the specified position, the level AI 2401 sends a message for starting the loop to the level 2400, to instruct the level 2400 to cyclically load the first module and the second module serving as loop modules. For example, in a case that the virtual character triggers the trigger of the first module, the level AI 2401 sends the message for starting the loop to the level 2400, to instruct the level 2400 to cyclically load the first module and the second module serving as loop modules.

Operation 2430: The level sends that the virtual character has completed the level.

In a case that the virtual character completes a task in the level, the level 2400 sends a message to the level AI 2401 that the virtual character has completed the level. For example, in a case that the virtual character defeats all monsters in the level, the level 2400 sends the message to the level AI 2401 that the virtual character has completed the level.

Operation 2440: The level AI sends “end the loop”.

After receiving the message that the virtual character has completed the level, the level AI 2401 sends a message for ending the loop to the level 2400, to instruct the level 2400 to end cyclically loading. For example, in a case that the virtual character defeats all monsters in the level, the level AI 2401 sends the message for ending the loop to the level 2400, to instruct the level 2400 to end the cyclically loading.

In conclusion, in the method provided in this aspect, in the trigger script solution, in a case that the loop is determined to be started, by cyclically loading the first module and the second module, the length of the level can be nearly infinite by loading only two modules by the client, thereby reducing performance pressure.

In the method provided in this aspect, further, in the AI script solution, the level AI receives an event in the level and instructs to start the loop or end the loop, to complete the task more uniformly, so that the length of the level can be nearly infinite by loading only two modules by the client, thereby reducing the performance pressure.

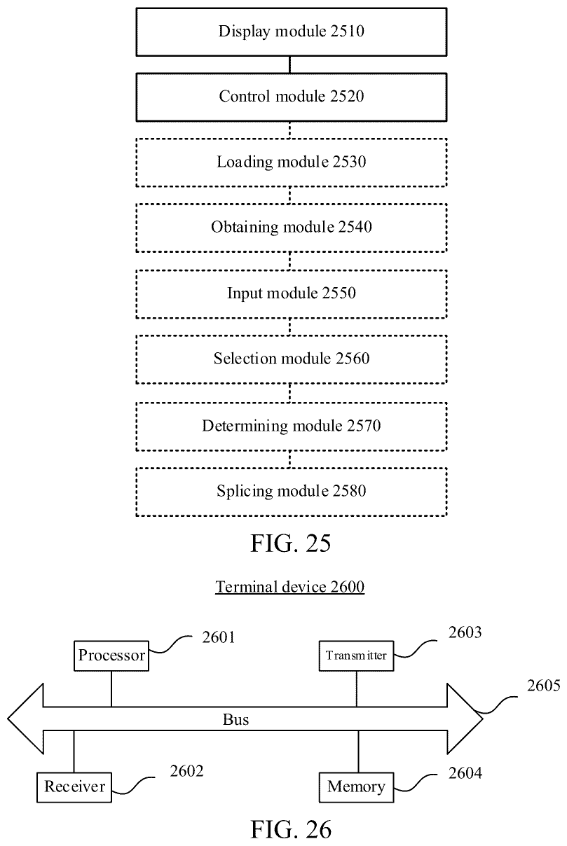

FIG. 25 is a block diagram of a level picture display apparatus according to an example of an aspect of this disclosure. The apparatus includes:
a display module 2510, configured to display a level picture, the level picture displaying a virtual character located in a first module; and
a control module 2520, configured to control, in response to a first interaction operation, the virtual character to move from an end position of the first module to a start position of a second module after completing a task of the first module;
configured to control, in response to a second interaction operation, the virtual character to move from an end position of the second module to a start position of the first module after completing a task of the second module; and
configured to repeat at least one of the foregoing two operations until in a case that a loop end condition is met, the virtual character is controlled to move from the end position of the first module or the second module to a start position of a third module.

In some aspects, the control module 2520 is configured to repeat at least one of the foregoing two operations until in a case that an attribute value of the target virtual character meets the loop end condition, the virtual character is controlled to move from the end position of the first module or the second module to the start position of the third module; or configured to repeat at least one of the foregoing two operations until a duration of the virtual character in the first module and/or the second module meets the loop end condition, the virtual character is controlled to move from the end position of the first module or the second module to the start position of the third module.

In some aspects, the control module 2520 is configured to control, in response to the first interaction operation, the virtual character to complete the task of the first module; and in a case that an attribute value of the target virtual character in the first module does not meet the loop end condition, control the virtual character to move from the end position of the first module to the start position of the second module, and control the target virtual character to move from the end position of the first module to the start position of the second module, where an attribute value of the target virtual character when the target virtual character appears in the second module inherits an attribute value of the target virtual character when the target virtual character leaves the first module.

In some aspects, the control module 2520 is configured to control, in response to the second interaction operation, the virtual character to complete the task of the second module; and in a case that an attribute value of the target virtual character in the second module does not meet the loop end condition, control the virtual character to move from the end position of the second module to the start position of the first module, and control the target virtual character to move from the end position of the second module to the start position of the first module, where an attribute value of the target virtual character when the target virtual character appears in the first module inherits an attribute value of the target virtual character when the target virtual character leaves the second module.

In some aspects, the apparatus further includes a loading module 2530, configured to preload a second module resource of the second module in a case that the virtual character moves to a first trigger position in the first module, the second module resource including: a second scene resource and a second virtual object resource appearing in the second module, the second virtual object resource including resources of all or some virtual objects appearing in the second module.

In some aspects, the apparatus further includes: an obtaining module 2540, configured to determine a number of loops of the second module;
an input module 2550, configured to input the number of loops as a seed into a pseudo-random algorithm to obtain a second random number; and
a selection module 2560, configured to determine virtual object types in the second virtual object resource and a quantity of virtual objects corresponding to each virtual object type based on the second random number.

In some aspects, the apparatus further includes: a determining module 2570, configured to determine a first line end point of a line in the first module; and determine a second line start point of a line in the second module; and a splicing module 2580, configured to splice the first line end point and the second line start point, to obtain a line connecting the first module to the second module.

In some aspects, the loading module 2530 is further configured to preload a first module resource of the first module in a case that the virtual character moves to a second trigger position in the second module, the first module resource including: a first scene resource and a first virtual object resource appearing in the first module, the first virtual object resource including resources of all or some virtual objects appearing in the first module.

In some aspects, the obtaining module 2540 is further configured to determine a number of loops of the first module;
the input module 2550 is further configured to input the number of loops as a seed into a pseudo-random algorithm to obtain a first random number; and
the selection module 2560 is further configured to determine virtual object types in the first virtual object resource and a quantity of virtual objects corresponding to each virtual object type based on the first random number.

In some aspects, the determining module 2570 is further configured to determine a second line end point of a line in the second module; and determine a first line start point of a line in the first module; and the splicing module 2580 is further configured to splice the second line end point and the first line start point, to obtain a line connecting the second module to the first module.

In some aspects, the loading module 2530 is further configured to trigger preloading of a third module resource of the third module in a case that the loop end condition is met in the first module, the third module resource including: a third scene resource and a third virtual object resource appearing in the third module, the third virtual object resource including resources of all or some virtual objects appearing in the third module.

In some aspects, the determining module 2570 is further configured to determine a first line end point of a line in the first module; and determine a third line start point of a line in the third module; and the splicing module 2580 is further configured to splice the first line end point and the third line start point, to obtain a line connecting the first module to the third module.

In some aspects, the loading module 2530 is further configured to trigger preloading of a third module resource of the third module in a case that the loop end condition is met in the second module, the third module resource including: a third scene resource and a third virtual object resource appearing in the third module, the third virtual object resource including resources of all or some virtual objects appearing in the third module.

In some aspects, the determining module 2570 is further configured to determine a second line end point of a line in the second module; and determine a third line start point of a line in the third module; and the splicing module 2580 is further configured to splice the second line end point and the third line start point, to obtain a line connecting the second module to the third module.

In some aspects, the display module 2510 is further configured to display a virtual character in a preceding module; and the loading module 2530 is further configured to preload the first module resource of the first module in a case that a loop start condition is met in the preceding module, the first module resource including: a first scene resource and a first virtual object resource appearing in the first module, the first virtual object resource including resources of all or some virtual objects appearing in the first module.

In some aspects, the determining module 2570 is further configured to determine a fourth line end point of a line in the preceding module; and determine a first line start point of a line in the first module; and the splicing module 2580 is further configured to splice the fourth line end point and the first line start point, to obtain a line connecting the preceding module to the first module.

FIG. 26 is a schematic structural diagram of a terminal device 2600 according to an example of an aspect of this disclosure. The terminal device 2600 includes: a processor 2601, a receiver 2602, a transmitter 2603, a memory 2604, and a bus 2605.

The processor 2601 includes one or more processing cores, and the processor 2601 performs various functional applications and information processing by running a software program and module.

The receiver 2602 and the transmitter 2603 may be implemented as a communication assembly. The communication assembly may be a communication chip. The communication assembly may be referred to as a transceiver.

The memory 2604 is connected to the processor 2601 through the bus 2605.

The memory 2604 may be configured to store at least one instruction, and the processor 2601 is configured to execute the at least one instruction to implement the operations in the foregoing method aspects.

In addition, the memory 2604 may be implemented by any type of volatile or non-volatile storage device or a combination thereof. The volatile or non-volatile storage device includes, but not limited to: a magnetic disk, an electrically-erasable programmable read only memory (EEPROM), an erasable programmable read only memory (EPROM), a static random access memory (SRAM), a read-only memory (ROM), a magnetic memory, a flash memory, or a programmable read-only memory (PROM).

In a possible implementation, the processor in the terminal device is configured to display a level picture, the level picture displaying the virtual character located in the first module; the processor in the terminal device is configured to control, in response to a first interaction operation, the virtual character to move from an end position of the first module to a start position of a second module after completing a task of the first module; the processor in the terminal device is configured to control, in response to a second interaction operation, the virtual character to move from an end position of the second module to a start position of the first module after completing a task of the second module; and the processor in the terminal device is configured to repeat at least one of the foregoing two operations until in a case that a loop end condition is met, the virtual character is controlled to move from the end position of the first module or the second module to a start position of a third module.

In an example of an aspect, a computer-readable storage medium such as a non-transitory computer-readable storage medium is further provided. The computer-readable storage medium has a computer program stored therein, the computer program being loaded and executed by a processor to implement the level picture display method provided in the foregoing method aspects.

In an example of an aspect, a computer program product is further provided. The computer program product, when run on a processor, causes a terminal device to implement the level picture display method according to the foregoing aspects. One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

A person of ordinary skill in the art may understand that all or some of the operations of implementing the foregoing aspects may be implemented by hardware, or may be implemented by a program instructing related hardware. The program may be stored in a computer-readable storage medium. The storage medium may be a read-only memory, a magnetic disk, or an optical disc.

The foregoing descriptions are merely example aspects of this disclosure, and are not intended to limit this disclosure. Any modification, equivalent replacement, or improvement made within the spirit and principle of this disclosure shall fall within the protection scope of this disclosure.

What is claimed is:

1. A display method, comprising:
displaying a virtual character that is located in a first module of a level in a video game;
controlling, based on a first interaction operation, the virtual character to move from an end position of a first instance of the first module to a start position of a first instance of a second module of the level in the video game when a first condition of the first module is met;
controlling, by processing circuitry and based on a second interaction operation, the virtual character to move from an end position of the first instance of the second module to a start position of a second instance of the first module when a second condition of the second module is met; and
controlling, by the processing circuitry and based on the second interaction operation, the virtual character to move from the end position of the first instance of the second module to a start position of a third module of the level in the video game when the second condition of the second module is met and a loop end condition is met.

2. The method according to claim 1, wherein the video game is a side-scrolling video game.

3. The method according to claim 1, wherein the virtual character is controlled to move to a plurality of instances of the first module and a plurality of instances of the second module until the loop end condition is met.

4. The method of claim 1, wherein
a target virtual character is displayed in at least one of the first instance of the first module or the second instance of the second module; and
that the loop end condition is met when an attribute value of the target virtual character is meets an attribute condition.

5. The method according to claim 4, wherein
the controlling, based on the first interaction operation, comprises:
controlling, based on the first interaction operation, the virtual character to complete a task that is associated with the first condition of the first module; and
when the attribute value of the target virtual character in the first module does not meet the attribute condition, controlling the virtual character to move from the end position of the first instance of the first module to the start position of the first instance of the second module, and controlling the target virtual character to move from the end position of the first instance of the first module to the start position of the first instance of the second module; and
the controlling, based on the second interaction operation, comprises:
controlling, based on the second interaction operation, the virtual character to complete a task that is associated with the second condition of the second module; and
when the attribute value of the target virtual character in the second module does not meet the attribute condition, controlling the virtual character to move from the end position of the first instance of the second module to the start position of the second instance of the first module, and controlling the target virtual character to move from the end position of the first instance of the second module to the start position of the second instance of the first module.

6. The method according to claim 1, further comprising:
preloading a second module resource of the first instance of the second module when the virtual character moves to a first trigger position in the first instance of the first module.

7. The method according to claim 6, further comprising:
determining a number of instances of the second module in the level of the game before the virtual character moved to the first trigger position in the first instance of the first module;
determining a first number based on the number of instances of the second module; and
determining at least one of virtual object types in a second virtual object resource or a quantity of virtual objects corresponding to each virtual object type based on the first number.

8. The method according to claim 6, further comprising:
determining a first line end point of a line in the first module and a second line start point of a line in the second module, the first line end point being a point at which movement ends on the line in the first module, and the second line start point being a point at which movement starts on the line in the second module; and
splicing the first line end point and the second line start point, to obtain a line connecting the first module to the second module.

9. The method according to claim 1, further comprising:
preloading a first module resource of the second instance of the first module when the virtual character moves to a second trigger position in the first instance of the second module.

10. The method according to claim 9, further comprising:
determining a number of instances of the first module in the level of the game before the virtual character moved to the second trigger position in the first instance of the second module;
determining a second number based on the number of instances of the first module; and
determining at least one of virtual object types in a first virtual object resource or a quantity of virtual objects corresponding to each virtual object type based on the second number.

11. The method according to claim 9, further comprising:
determining a second line end point of a line in the second module and a first line start point of a line in the first module, the second line end point being a point at which movement ends on the line in the second module, and the first line start point being a point at which movement starts on the line in the first module; and
splicing the second line end point and the first line start point, to obtain a line connecting the second module to the first module.

12. The method according to claim 1, further comprising:
triggering preloading of a third module resource of the third module when the loop end condition is met in one of the first module and the second module.

13. The method according to claim 1, further comprising:
determining an end point of a line in the one of the second instance of the first module and the first instance of the second module and a start point of a line in the third module, the end point of the line in the one of the second instance of the first module and the first instance of the second module being a point at which movement ends on the line in the one of the second instance of the first module and the first instance of the second module, and the start point of the third module being a point at which movement starts on the line in the third module; and
splicing the end point of the line in the one of the second instance of the first module and the first instance of the second module and the third line start point, to obtain a line connecting the first module to the third module.

14. The method according to claim 1, further comprising:
displaying the virtual character in a preceding module; and
preloading a first module resource of the first instance of the first module when a loop start condition is met in the preceding module.

15. The method according to claim 14, further comprising:
determining a preceding line end point of a line in the preceding module and a first line start point of a line in the first instance of the first module, the preceding line end point being a point at which movement ends on the line in the preceding module, and the first line start point being a point at which movement starts on the line in the first instance of the first module; and
splicing the preceding line end point and the first line start point, to obtain a line connecting the preceding module to the first instance of the first module.

16. An information processing apparatus, comprising:
processing circuitry configured to:
display a virtual character that is located in a first module of a level in a video game;
control, based on a first interaction operation, the virtual character to move from an end position of a first instance of the first module to a start position of a first instance of a second module of the level in the video game when a first condition of the first module is met;
control, by processing circuitry and based on a second interaction operation, the virtual character to move from an end position of the first instance of the second module to a start position of a second instance of the first module when a second condition of the second module is met; and
controlling, by the processing circuitry and based on the second interaction operation, the virtual character to move from the end position of the first instance of the second module to a start position of a third module of the level in the video game when the second condition of the second module is met and a loop end condition is met.

17. The information processing apparatus according to claim 16, wherein the video game is a side-scrolling video game.

18. The information processing apparatus according to claim 16, wherein the virtual character is controlled to move to a plurality of instances of the first module and a plurality of instances of the second module until the loop end condition is met.

19. A non-transitory computer-readable storage medium, storing instructions which when executed by a processor cause the processor to perform:
displaying a virtual character that is located in a first module of a level in a video game;
controlling, based on a first interaction operation, the virtual character to move from an end position of a first instance of the first module to a start position of a first instance of a second module of the level in the video game when a first condition of the first module is met;
controlling, based on a second interaction operation, the virtual character to move from an end position of the first instance of the second module to a start position of a second instance of the first module when a second condition of the second module is met; and
controlling, based on the second interaction operation, the virtual character to move from the end position of the first instance of the second module to a start position of a third module of the level in the video game when the second condition of the second module is met and a loop end condition is met.

20. The non-transitory computer-readable storage medium according to claim 19, wherein the virtual character is controlled to move to a plurality of instances of the first module and a plurality of instances of the second module until the loop end condition is met.
